(19) United States
(12) Patent Application Publication
(10) Pub. No.: US 2018/0224802 A1
(43) Pub. Date: Aug. 9, 2018

(54) SYSTEM AND METHOD PRESENTING HOLOGRAPHIC PLANT GROWTH

(71) Applicant: Microsoft Technology Licensing, LLC, Redmond, WA (US)

(72) Inventors: Jaldeep R. Vasavada, Hyderabad (IN); Ranganath Kondapally, Hyderabad (IN); Sree Hari Nagaralu, Hyderabad (IN); Pavan Kumar Dasari, Hyderabad (IN); Mounika Chiliveri, Hyderabad (IN); Venkata Chaitanya Gurram, Hyderabad (IN); Saurabh Sood, Hyderabad (IN)

(21) Appl. No.: 15/428,778

(22) Filed: Feb. 9, 2017

(51) Int. Cl. G03H 1/00; G03H 1/08; G02B 27/01; G06F 3/01; G09B 25/08; G09B 19/00; G09B 9/00

(52) U.S. Cl. CPC G03H 1/0005; G03H 1/08; G02B 27/0103; G02B 27/0172; G06F 3/017; G02B 2027/0178; G09B 19/00; G09B 9/00; G03H 2001/0061; G02B 2027/0174; G09B 25/08

(57) ABSTRACT

A system and method are disclosed for generating holographic plant life, which can grow over time, so that a user can see them mature, either in real time or in an accelerated timeframe. The environmental impact of the growth of plants may also be virtually depicted, such as for example displaying holographic birds, insects or other wildlife that may inhabit plants as they grow. The present technology brings users closer to nature and inspires them to plant real trees and other foliage.

### BACKGROUND

Trees and other plants are vital to a sustainable environment. With global warming and deforestation, there are several initiatives aimed at raising public awareness about the importance of trees and other plants to the sustenance of a healthy environment. To date, these initiatives have included programs to raise funds and donations for the planting of new trees. However, these programs are in competition with other charitable initiatives and their effectiveness to date has been limited. Other programs involve getting people to plant their own trees. However, many have been unwilling to undertake such a project, given that they lack the knowledge of how and what to plant in a given area, as well as what it takes to successfully grow and maintain their own trees or other plants.

### SUMMARY

Embodiments of the present technology relate to a system and method for generating holographic plant life, which can grow over time, so that a user can see the plants mature, either in real time or in a user controllable accelerated timeframe. The holographic plant life may be positioned within an open field or other area, and viewed through an augmented reality (AR) device, such as for example a head mounted display device. The environmental impact of the growth of plants may also be virtually depicted, such as for example displaying holographic birds, insects or other wildlife that may inhabit plants as they grow, as well as showing the effects of the wildlife on the plants. In addition to wildlife, the present technology can show further effects of the holographic plants on the environment, such as for example changing weather patterns and increased shade.

Allowing users to generate and grow holographic trees and other plants has several benefits. Displaying holographic plants brings users closer to nature by enabling users to virtually experience nature that could exist in the real world if real trees and other foliage were planted. Users may experience aesthetic and stress-relieving benefits from the holographic plants and wildlife, which will inspire the user to plant real trees and other foliage. The present technology further educates users in the planting and growing of trees and other foliage, and provides recommendations and information on plants that will do well in a given area. This feature again inspires users to create trees and other plants in the real world.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is an illustration of an augmented reality environment including real and holographic objects.

FIG. 2 is a perspective view of one embodiment of a head mounted display unit.

FIG. 3 is a side view of a portion of one embodiment of a head mounted display unit.

FIG. 4 is a block diagram of one embodiment of the components of a head mounted display unit.

FIG. 5 is a block diagram of one embodiment of the components of a processing unit associated with a head mounted display unit.

FIG. 6 is a block diagram of one embodiment of the software components of a processing unit associated with the head mounted display unit.

FIG. 7 is a flowchart showing the operation of one or more processing units associated with a head mounted display unit.

FIGS. 8-9 are more detailed flowcharts of examples of steps 614 and 626 shown in the flowchart of FIG. 7.

FIG. 10 is an illustration of an augmented reality environment including users generating holographic objects.

FIG. 11 is a more detailed flowchart of examples of step 632 shown in the flowchart of FIG. 7.

FIGS. 12-14 are illustrations of an augmented reality environment according to further embodiments of the present technology.

### DETAILED DESCRIPTION

Embodiments of the present technology will now be described with reference to the figures, which in general relate to a system and method for generating holographic plant life, which can grow or wither over time, depending on environmental conditions and/or user care. A user is able to create holographic plant life, and then, with proper conditions, watch the holographic plants grow over time into fully mature plants, either in real time or in an accelerated timeframe.

The environmental impact of the growth of plants may also be virtually depicted, such as for example displaying holographic birds, insects or other wildlife that may inhabit plants as they grow, and show the responsive effects of the wildlife on the plants. Other impacts on the environment from the growth of plants may be shown, such as changing weather patterns, improved air quality and increased shade.

The holographic plant life may be generated outdoors, for example superimposed over a real world field or other area. Holographic plant life may alternatively be displayed indoors, such as for example as hanging or potted holographic plants. In a further example, holographic plant life may be generated along roadways and railways, and displayed to users as they pass by. Each of these examples is explained in greater detail below.

The holographic plants and other images may be generated and displayed by an augmented reality device. In embodiments described below, the augmented reality device is described as a mobile processing unit comprising a processor and a head mounted display device. However, it is understood that any of various other augmented reality devices may be used to generate and display holographic plants and other features of the present technology. For example, the augmented reality device may be a hand-held device such as a tablet or smart phone, which displays holographic plants overlaid on a real world scene captured by a camera in the hand-held device. Other augmented reality devices are contemplated.

In embodiments using a head mounted display device, the device may include a display element which is to a degree transparent so that a user can look through the display element at real world objects within the user's field of view (FOV). The display element also provides the ability to project holographic images into the FOV of the user such that the holographic images may also appear alongside the real world objects. The system automatically tracks where the user is looking so that the system can determine where to insert a holographic image in the FOV of the user. Once the system knows where to project the holographic image, the image is projected using the display element.

In embodiments, the processor may build a model of the environment including the x, y, z Cartesian positions of one or more users, real world objects and holographic three-dimensional objects. Where there are multiple users viewing the same holographic objects, the positions of each head mounted display device may be calibrated to the model of the environment. This allows the system to determine each user's line of sight and FOV of the environment. Thus, a holographic image may be displayed to each user, but the system determines the display of the holographic image from each user's perspective, adjusting the holographic image for parallax and any occlusions of or by other objects in the environment. The three-dimensional model of the environment, referred to herein as a scene map, as well as all tracking of each user's FOV and objects in the environment may be generated by the mobile processing unit by itself, or working in tandem with other processing devices as explained hereinafter.

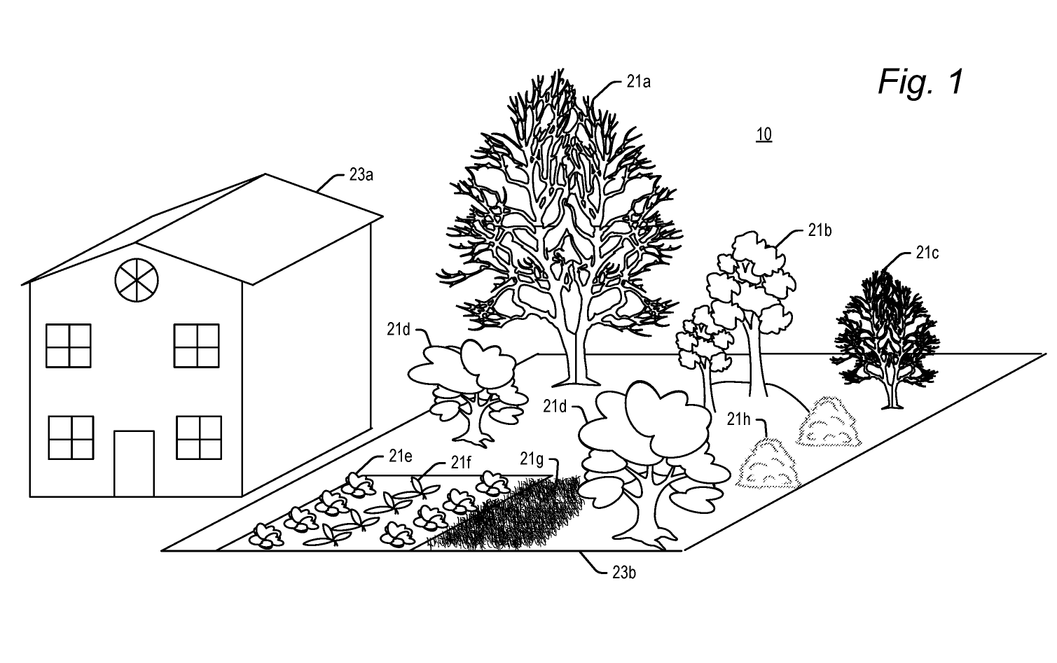

FIG. 1 illustrates a mixed reality environment 10 as viewed through a head mounted display device of a mobile processing unit (not shown in FIG. 1). The mobile processing unit provides a mixed reality experience to users by fusing holographic objects 21 with real objects 23 within each user's FOV. FIG. 1 shows real objects 23 in the form of a house 23a and a field 23b next to the house. FIG. 1 also shows a variety of holographic objects 21 in the form of holographic plants 21, including for example holographic trees 21a-d, produce 21e-f, grass 21g and shrubs 21h. However, in general, the terms “plant” and “plant life” as used herein may refer to any living organism which absorbs water through a system of roots, and/or which synthesizes nutrients by photosynthesis. Such plants include but are not limited to trees, produce, grass, shrubs, flowers, herbs, ferns and mosses.

It is understood that the particular holographic content shown in FIG. 1 is by way of example only, and may be any of a wide variety of holographic plants and, as explained below, wildlife. The type, number, sizes and/or positions of holographic objects may be user defined, or defined by an application run by the mobile processing unit as explained below. Also, while the holographic plants 21 are shown in field 23b next to a house 23a, it is understood that the holographic plants 21 may be generated and placed in any of a wide variety of other locations, including indoors (e.g., holographic house plants), outdoors, on or over balconies and hanging off of interior or exterior walls or other structures. It is also understood that the holographic plants 21 may be provided in a wide variety of outdoor settings, including but not limited to fields, lawns, gardens, agricultural land, forests, parks and urban areas. Some plants are known to flourish on water, and holographic plants of these kinds may be generated on real bodies of water.

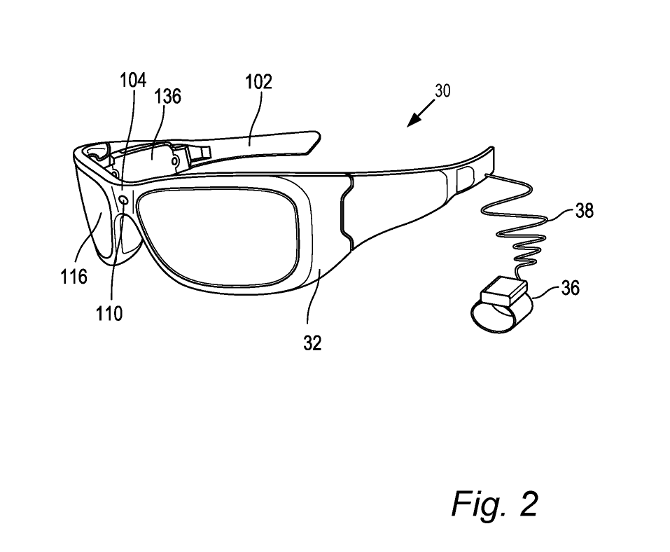

FIG. 2 illustrates a mobile processing device 30 including a head mounted display device 32 which may include or be in communication with its own processing unit 36, for example via a flexible wire 38. The head mounted display device may alternatively communicate wirelessly with the processing unit 36. In further embodiments, the processing unit 36 may be integrated into the head mounted display device 32. Head mounted display device 32, which in one embodiment is in the shape of glasses, is worn on the head of a user so that the user can see through a display and thereby have an actual direct view of the space in front of the user. More details of the head mounted display device 32 and processing unit 36 are provided below.

Where not incorporated into the head mounted display device 32, the processing unit 36 may be a small, portable device for example worn on the user's wrist or stored within a user's pocket. The processing unit 36 may include hardware components and/or software components to execute applications such as a plant generation and growth application according to embodiments of the present technology explained below. In one embodiment, processing unit 36 may include a processor such as a standardized processor, a specialized processor, a microprocessor, or the like that may execute instructions stored on a processor readable storage device for performing the processes described herein. In embodiments, the processing unit 36 may communicate wirelessly (e.g., WiFi, Bluetooth, infra-red, or other wireless communication means) with one or more remote computing systems. These remote computing systems may include a computer or a remote service provider. In further embodiments, the processing unit 36 may be a mobile phone or other cellular device, or the processing unit may have a wired or wireless connection to a mobile cellular device.

The head mounted display device 32 and processing unit 36 of the mobile processing device 30 may cooperate with each other to present holographic objects 21 to a user in a mixed reality environment 10. The details of the head mounted display device 32 and processing unit 36 which enable the display of holographic plants that grow over time will now be explained with reference to FIGS. 2-6.

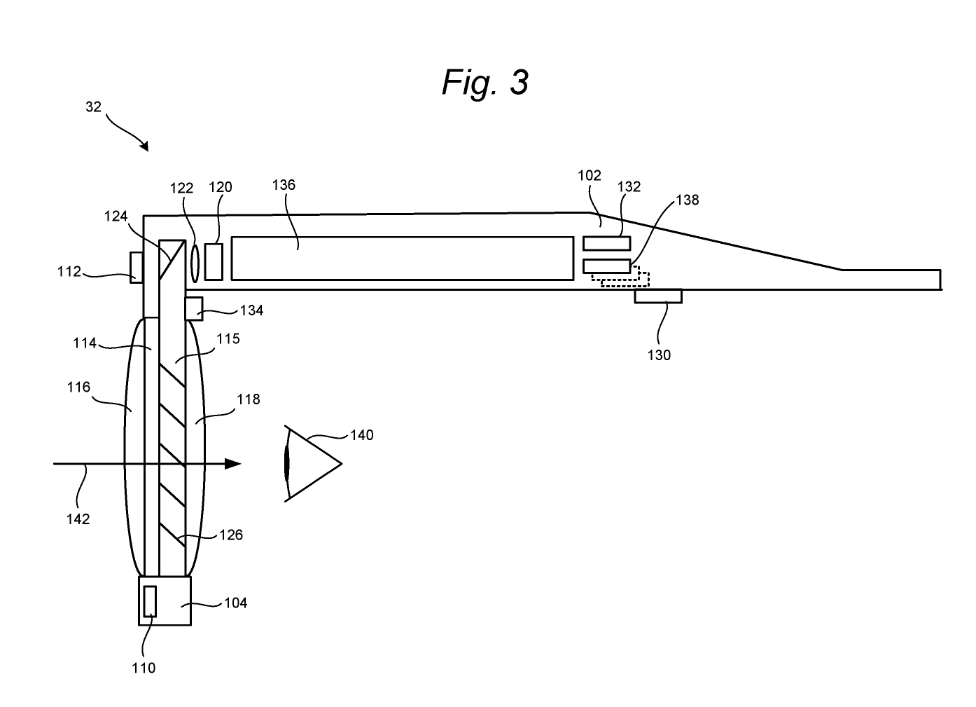

FIGS. 2 and 3 show perspective and side views of the head mounted display device 32. FIG. 3 shows only the right side of head mounted display device 32, including a portion of the device having temple 102 and nose bridge 104. Built into nose bridge 104 is a microphone 110 for recording sounds and transmitting that audio data to processing unit 36, as described below. At the front of head mounted display device 32 is forward-facing video camera 112 that can capture video and still images. Those images are transmitted to processing unit 36, as described below. While a particular configuration is shown, it is understood that the position of the various components and sensors within the head mounted display device 32 may vary.

A portion of the frame of head mounted display device 32 will surround a display (that includes one or more lenses). In order to show the components of head mounted display device 32, a portion of the frame surrounding the display is not depicted. The display includes a light-guide optical element 115, opacity filter 114, see-through lens 116 and see-through lens 118. In one embodiment, opacity filter 114 is behind and aligned with see-through lens 116, light-guide optical element 115 is behind and aligned with opacity filter 114, and see-through lens 118 is behind and aligned with light-guide optical element 115. See-through lenses 116 and 118 are standard lenses used in eye glasses and can be made to any prescription (including no prescription). In one embodiment, see-through lenses 116 and 118 can be replaced by a variable prescription lens. Opacity filter 114 filters out natural light (either on a per pixel basis or uniformly) to enhance the contrast of the virtual imagery. Light-guide optical element 115 channels artificial light to the eye. More details of opacity filter 114 and light-guide optical element 115 are provided below.

Mounted to or inside temple 102 is an image source, which (in one embodiment) includes microdisplay 120 for projecting a holographic image, and lens 122 for directing images from microdisplay 120 into light-guide optical element 115. In one embodiment, lens 122 is a collimating lens.

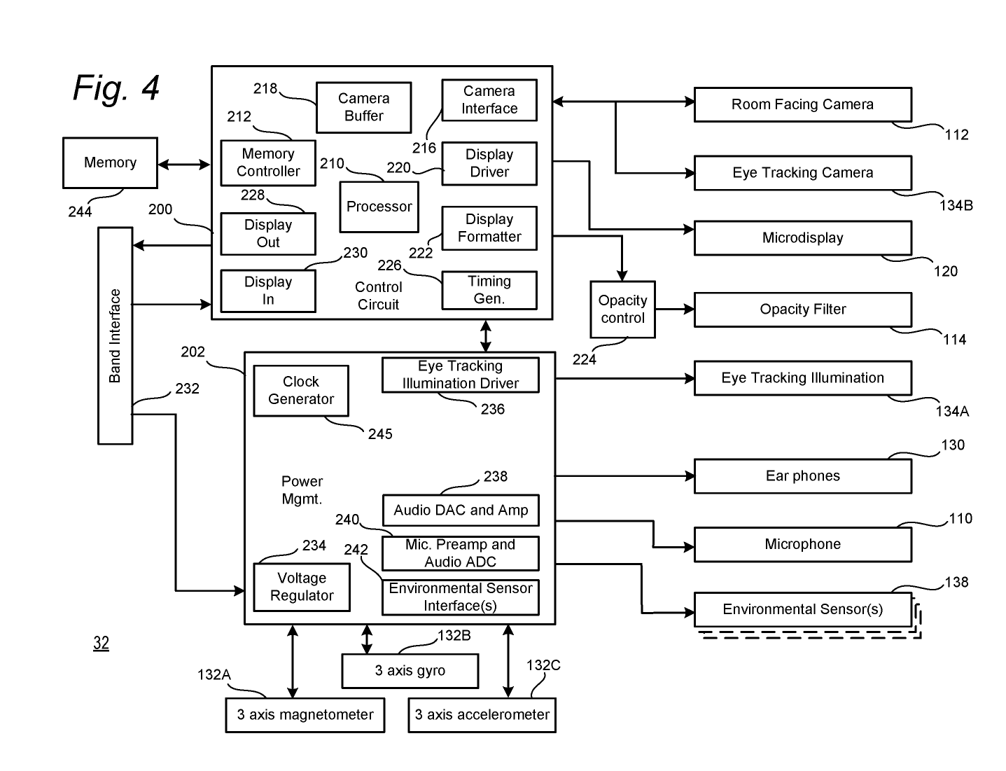

Control circuits 136 may be provided within the head mounted display device 32 for supporting various components of head mounted display device 32. More details of control circuits 136 are provided below with respect to FIG. 4. Inside or mounted to temple 102 are ear phones 130 and inertial measurement unit 132. In one embodiment shown in FIG. 4, the inertial measurement unit 132 (or IMU 132) includes inertial sensors such as a three axis magnetometer 132A, three axis gyro 132B and three axis accelerometer 132C. The inertial measurement unit 132 senses position, orientation, and sudden accelerations (pitch, roll and yaw) of head mounted display device 32. The IMU 132 may include other inertial sensors in addition to or instead of magnetometer 132A, gyro 132B and accelerometer 132C.

The head mounted display device 32 may further include one or more environmental sensors 138. The environmental sensors may include a temperature sensor, a humidity sensor, an atmospheric pressure sensor, a rain sensor, an air quality sensor and/or an airborne particulate sensor. The configuration of these sensors may be known in the art. It is understood that the environmental sensors 138 may include other or additional sensors for sensing environmental parameters. As explained below, the feedback from the one or more environmental sensors may be used by the processing unit to determine rate of growth of the holographic plants displayed to a user.

Microdisplay 120 projects an image through lens 122. There are different image generation technologies that can be used to implement microdisplay 120. For example, microdisplay 120 can be implemented in using a transmissive projection technology where the light source is modulated by optically active material, backlit with white light. These technologies are usually implemented using LCD type displays with powerful backlights and high optical energy densities. Microdisplay 120 can also be implemented using a reflective technology for which external light is reflected and modulated by an optically active material. The illumination is forward lit by either a white source or RGB source, depending on the technology. Digital light processing (DLP), liquid crystal on silicon (LCOS) and Mirasol® display technology from Qualcomm, Inc. are examples of reflective technologies which are efficient as most energy is reflected away from the modulated structure and may be used in the present system. Additionally, microdisplay 120 can be implemented using an emissive technology where light is generated by the display. For example, a PicoP™ display engine from Microvision, Inc. emits a laser signal with a micro mirror steering either onto a tiny screen that acts as a transmissive element or beamed directly into the eye (e.g., laser).

Light-guide optical element 115 transmits light from microdisplay 120 to the eye 140 of the user wearing head mounted display device 32. Light-guide optical element 115 also allows light from in front of the head mounted display device 32 to be transmitted through light-guide optical element 115 to eye 140, as depicted by arrow 142, thereby allowing the user to have an actual direct view of the space in front of head mounted display device 32 in addition to receiving a virtual image from microdisplay 120. Thus, the walls of light-guide optical element 115 are see-through. Light-guide optical element 115 includes a first reflecting surface 124 (e.g., a mirror or other surface). Light from microdisplay 120 passes through lens 122 and becomes incident on reflecting surface 124. The reflecting surface 124 reflects the incident light from the microdisplay 120 such that light is trapped inside a planar substrate comprising light-guide optical element 115 by internal reflection. After several reflections off the surfaces of the substrate, the trapped light waves reach an array of selectively reflecting surfaces 126. Note that only one of the five surfaces is labeled 126 to prevent over-crowding of the drawing. Reflecting surfaces 126 couple the light waves incident upon those reflecting surfaces out of the substrate into the eye 140 of the user.

As different light rays will travel and bounce off the inside of the substrate at different angles, the different rays will hit the various reflecting surfaces 126 at different angles. Therefore, different light rays will be reflected out of the substrate by different ones of the reflecting surfaces. The selection of which light rays will be reflected out of the substrate by which reflecting surface 126 is engineered by selecting an appropriate angle of the reflecting surfaces 126. More details of a light-guide optical element can be found in United States Patent Publication No. 2008/0285140, entitled “Substrate-Guided Optical Devices,” published on Nov. 20, 2008. In one embodiment, each eye will have its own light-guide optical element 115. When the head mounted display device 32 has two light-guide optical elements, each eye can have its own microdisplay 120 that can display the same image in both eyes or different images in the two eyes. In another embodiment, there can be one light-guide optical element which reflects light into both eyes.

Opacity filter 114, which is aligned with light-guide optical element 115, selectively blocks natural light, either uniformly or on a per-pixel basis, from passing through light-guide optical element 115. Details of an example of opacity filter 114 are provided in U.S. Patent Publication No. 2012/0068913 to Bar-Zeev et al., entitled “Opacity Filter For See-Through Mounted Display,” filed on Sep. 21, 2010. However, in general, an embodiment of the opacity filter 114 can be a see-through LCD panel, an electrochromic film, or similar device which is capable of serving as an opacity filter. Opacity filter 114 can include a dense grid of pixels, where the light transmissivity of each pixel is individually controllable between minimum and maximum transmissivities. While a transmissivity range of 0-100% is ideal, more limited ranges are also acceptable, such as for example about 50% to 90% per pixel.

Head mounted display device 32 also includes a system for tracking the position of the user's eyes. The system will track the user's position and orientation so that the system can determine the FOV of the user. However, a human will not perceive everything in front of them. Instead, a user's eyes will be directed at a subset of the environment. Therefore, in one embodiment, the system will include technology for tracking the position of the user's eyes in order to refine the measurement of the FOV of the user. For example, head mounted display device 32 includes eye tracking assembly 134 (FIG. 3), which has an eye tracking illumination device 134A and eye tracking camera 134B (FIG. 4). In one embodiment, eye tracking illumination device 134A includes one or more infrared (IR) emitters, which emit IR light toward the eye. Eye tracking camera 134B includes one or more cameras that sense the reflected IR light. The position of the pupil can be identified by known imaging techniques which detect the reflection of the cornea. For example, see U.S. Pat. No. 7,401,920, entitled “Head Mounted Eye Tracking and Display System”, issued Jul. 22, 2008. Such a technique can locate a position of the center of the eye relative to the tracking camera. Generally, eye tracking involves obtaining an image of the eye and using computer vision techniques to determine the location of the pupil within the eye socket. In one embodiment, it is sufficient to track the location of one eye since the eyes usually move in unison. However, it is possible to track each eye separately.

FIG. 3 only shows half of the head mounted display device 32. A full head mounted display device may include another set of see-through lenses, another opacity filter, another light-guide optical element, another microdisplay 120, another lens 122, another forward-facing camera, another eye tracking assembly 134, earphones, and one or more additional environmental sensors.

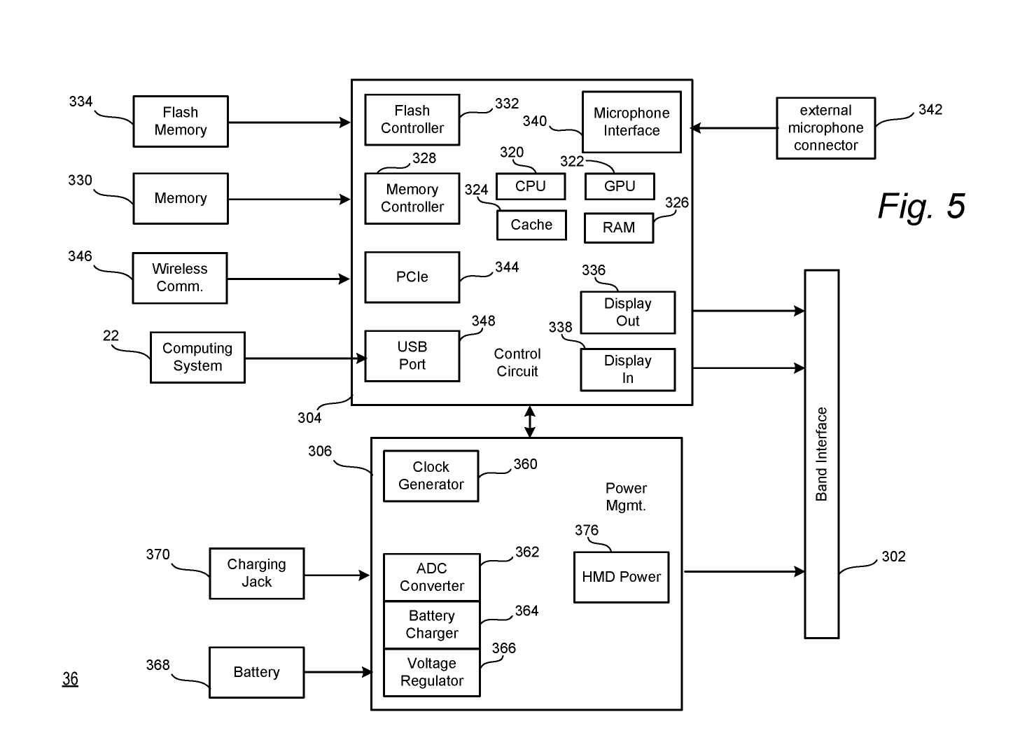

FIG. 4 is a block diagram depicting the various components of head mounted display device 32. FIG. 5 is a block diagram describing the various components of processing unit 36. Head mounted display device 32, the components of which are depicted in FIG. 4, is used to provide a virtual experience to the user by fusing one or more virtual images seamlessly with the user's view of the real world. Additionally, the head mounted display device components of FIG. 4 include many sensors that track various conditions. Head mounted display device 32 will receive instructions about the virtual image from processing unit 36 and will provide the sensor information back to processing unit 36. Processing unit 36 may determine where and when to provide a virtual image to the user and send instructions accordingly to the head mounted display device of FIG. 4.

Some of the components of FIG. 4 (e.g., forward-facing camera 112, eye tracking camera 134B, microdisplay 120, opacity filter 114, eye tracking illumination 134A) are shown in shadow to indicate that there may be two of each of those devices, one for the left side and one for the right side of head mounted display device 32. FIG. 4 shows the control circuit 200 in communication with the power management circuit 202. Control circuit 200 includes processor 210, memory controller 212 in communication with memory 214 (e.g., D-RAM), camera interface 216, camera buffer 218, display driver 220, display formatter 222, timing generator 226, display out interface 228, and display in interface 230.

In one embodiment, the components of control circuit 200 are in communication with each other via dedicated lines or one or more buses. In another embodiment, the components of control circuit 200 are in communication with processor 210. Camera interface 216 provides an interface to the two forward-facing cameras 112 and stores images received from the forward-facing cameras in camera buffer 218. Display driver 220 will drive microdisplay 120. Display formatter 222 provides information, about the virtual image being displayed on microdisplay 120, to opacity control circuit 224, which controls opacity filter 114. Timing generator 226 is used to provide timing data for the system. Display out interface 228 is a buffer for providing images from forward-facing cameras 112 to the processing unit 36. Display in interface 230 is a buffer for receiving images such as a virtual image to be displayed on microdisplay 120. Display out interface 228 and display in interface 230 communicate with band interface 232 which is an interface to processing unit 36.

Power management circuit 202 includes voltage regulator 234, eye tracking illumination driver 236, audio DAC and amplifier 238, microphone preamplifier and audio ADC 240, environmental sensor interface(s) 242 and clock generator 245. Voltage regulator 234 receives power from processing unit 36 via band interface 232 and provides that power to the other components of head mounted display device 32. Eye tracking illumination driver 236 provides the IR light source for eye tracking illumination 134A, as described above. Audio DAC and amplifier 238 output audio information to the earphones 130. Microphone preamplifier and audio ADC 240 provide an interface for microphone 110. Environmental sensor interface 242 comprises one or more interfaces adapted to receive input from respective ones of the one or more environmental sensors 138. Power management circuit 202 also provides power and receives data back from three axis magnetometer 132A, three axis gyro 132B and three axis accelerometer 132C.

FIG. 5 is a block diagram describing the various components of processing unit 36. FIG. 5 shows control circuit 304 in communication with power management circuit 306. Control circuit 304 includes a central processing unit (CPU) 320, graphics processing unit (GPU) 322, cache 324, RAM 326, memory controller 328 in communication with memory 330 (e.g., D-RAM), flash memory controller 332 in communication with flash memory 334 (or other type of non-volatile storage), display out buffer 336 in communication with head mounted display device 32 via band interface 302 and band interface 232, display in buffer 338 in communication with head mounted display device 32 via band interface 302 and band interface 232, microphone interface 340 in communication with an external microphone connector 342 for connecting to a microphone, PCI express interface for connecting to a wireless communication device 346, and USB port(s) 348. In one embodiment, wireless communication device 346 can include a Wi-Fi enabled communication device, Bluetooth communication device, infrared communication device, etc. The USB port can be used to dock the processing unit 36 to processing unit computing system 22 in order to load data or software onto processing unit 36, as well as charge processing unit 36. In one embodiment, CPU 320 and GPU 322 are the main workhorses for determining where, when and how to insert virtual three-dimensional objects into the view of the user. More details are provided below.

Power management circuit 306 includes clock generator 360, analog to digital converter 362, battery charger 364, voltage regulator 366 and head mounted display power source 376. Analog to digital converter 362 is used to monitor the battery voltage, the temperature sensor and control the battery charging function. Voltage regulator 366 is in communication with battery 368 for supplying power to the system. Battery charger 364 is used to charge battery 368 (via voltage regulator 366) upon receiving power from charging jack 370. HMD power source 376 provides power to the head mounted display device 32. As indicated, the components of the processing unit 36 shown in FIG. 5 may be integrated into the head mounted display device 32 shown in FIG. 4

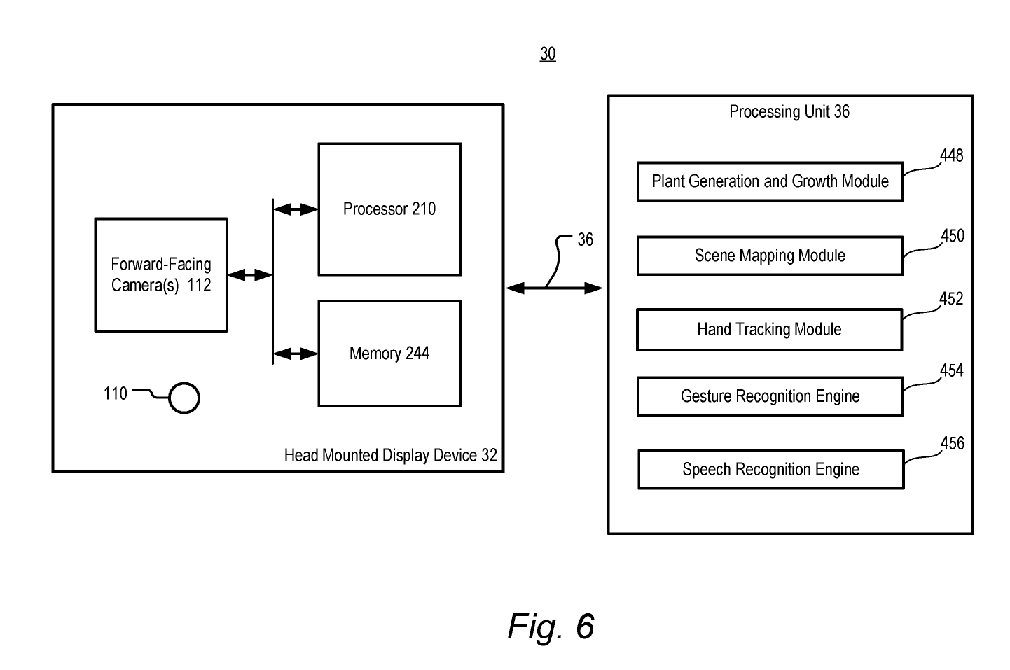

FIG. 6 illustrates a high-level block diagram of the mobile processing device 30 including the forward-facing camera 112 of the display device 32 and some of the software modules on the processing unit 36. As noted, at least portions of the processing unit 36 may be integrated into the head mounted display device 32, so that some or all of the software modules shown may be implemented on a processor 210 of the head mounted display device 32. As shown, the forward-facing camera 112 provides image data to the processor 210 in the head mounted display device 32. In one embodiment, the forward-facing camera 112 may include a depth camera, an RGB camera and/or an IR light component to capture image data of a scene. As explained below, the forward-facing camera 112 may include less than all of these components.

Using for example time-of-flight analysis, the IR light component may emit an infrared light onto the scene and may then use sensors (not shown) to detect the backscattered light from the surface of one or more objects in the scene using, for example, the depth camera and/or the RGB camera. In some embodiments, pulsed infrared light may be used such that the time between an outgoing light pulse and a corresponding incoming light pulse may be measured and used to determine a physical distance from the forward-facing camera 112 to a particular location on the objects in the scene, including for example a user's hands. Additionally, in other example embodiments, the phase of the outgoing light wave may be compared to the phase of the incoming light wave to determine a phase shift. The phase shift may then be used to determine a physical distance from the capture device to a particular location on the targets or objects.

According to another example embodiment, time-of-flight analysis may be used to indirectly determine a physical distance from the forward-facing camera 112 to a particular location on the objects by analyzing the intensity of the reflected beam of light over time via various techniques including, for example, shuttered light pulse imaging.

In another example embodiment, the forward-facing camera 112 may use a structured light to capture depth information. In such an analysis, patterned light (i.e., light displayed as a known pattern such as a grid pattern, a stripe pattern, or different pattern) may be projected onto the scene via, for example, the IR light component. Upon striking the surface of one or more targets or objects in the scene, the pattern may become deformed in response. Such a deformation of the pattern may be captured by, for example, the 3-D camera and/or the RGB camera (and/or other sensor) and may then be analyzed to determine a physical distance from the forward-facing camera 112 to a particular location on the objects. In some implementations, the IR light component is displaced from the depth and/or RGB cameras so triangulation can be used to determined distance from depth and/or RGB cameras. In some implementations, the forward-facing camera 112 may include a dedicated IR sensor to sense the IR light, or a sensor with an IR filter.

It is understood that the present technology may sense objects and three-dimensional positions of the objects without each of a depth camera, RGB camera and IR light component. In embodiments, the forward-facing camera 112 may for example work with just a standard image camera (RGB or black and white). Such embodiments may operate by a variety of image tracking techniques used individually or in combination. For example, a single, standard image forward-facing camera 112 may use feature identification and tracking. That is, using the image data from the standard camera, it is possible to extract interesting regions, or features, of the scene. By looking for those same features over a period of time, information for the objects may be determined in three-dimensional space.

In embodiments, the head mounted display device 32 may include two spaced apart standard image forward-facing cameras 112. In this instance, depth to objects in the scene may be determined by the stereo effect of the two cameras. Each camera can image some overlapping set of features, and depth can be computed from the parallax difference in their views.

A further method for determining a scene map with positional information within an unknown environment is simultaneous localization and mapping (SLAM). One example of SLAM is disclosed in U.S. Pat. No. 7,774,158, entitled “Systems and Methods for Landmark Generation for Visual Simultaneous Localization and Mapping.” Additionally, data from the IMU can be used to interpret visual tracking data more accurately.

In accordance with the present technology, the processing unit 36 may implement a plant generation and growth module 448. The operation of the plant generation and growth module is explained below, but in general, the module performs at least two functions. First, the module 448 generates holographic objects, including holographic plants and, possibly, holographic wildlife. The module 448 may generate the holographic objects based at least in part on user input, for example as to the type of plant to generate, where to put it, and the size at which it begins. Each of these features of the holographic objects may alternatively be automatically generated by the plant generation and growth module 448.

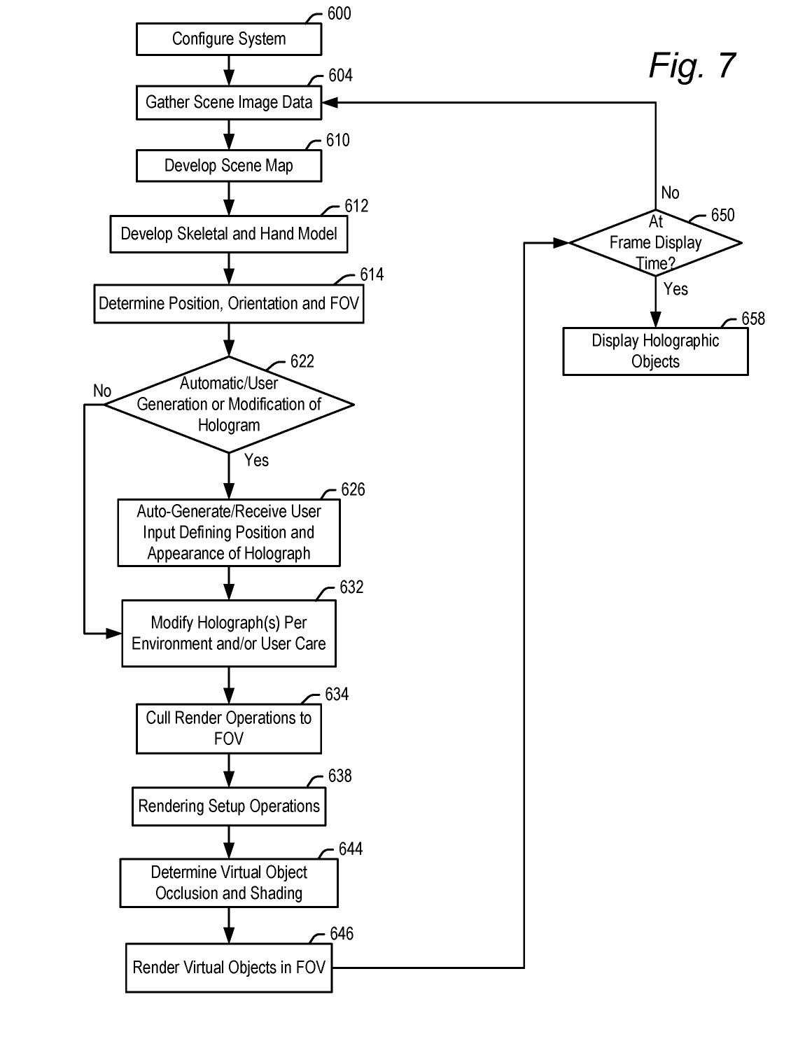

Additionally, based on feedback from the head mounted display device, including from the environmental sensors 138, the plant generation and growth module 448 may also change the appearance of one or more of the holographic plants so that they appear to grow (or whither) over time. These features are explained below with reference to the flowcharts of FIGS. 7-9 and 11.

The processing unit 36 may include a scene mapping module 450. Using the data from the front-facing camera(s) 112 as described above, the scene mapping module is able to map objects in the scene to the scene map which is a three-dimensional frame of reference. The scene map may map objects such as one or both of the user's hands and the real world objects 23 of FIG. 1. Further details of the scene mapping module are described below.

In embodiments noted above, a user may provide input as to where to place holographic objects and how to size them. In one embodiment, the processing unit 36 may execute a hand recognition and tracking module 452 to facilitate this user input. The module 452 receives the image data from the forward-facing camera 112 and is able to identify a user's hand, and a position of the user's hand, in the FOV. An example of the hand recognition and tracking module 452 is disclosed in U.S. Patent Publication No. 2012/0308140, entitled, “System for Recognizing an Open or Closed Hand.” In general the module 452 may examine the image data to discern width and length of objects which may be fingers, spaces between fingers and valleys where fingers come together so as to identify and track a user's hands in their various positions. With this information, the mobile processing device 30 is able to detect where a user is placing holographic objects and how big the user wishes to make the holographic objects.

The processing unit 36 may further include a gesture recognition engine 454 for receiving skeletal model and/or hand data for one or more users in the scene and determining whether the user is performing a predefined gesture or application-control movement affecting an application running on the processing unit 36. More information about gesture recognition engine 454 can be found in U.S. patent application Ser. No. 12/422,661, entitled “Gesture Recognizer System Architecture,” filed on Apr. 13, 2009.

In embodiments, a user may perform various verbal gestures, for example in the form of spoken commands to select holographic objects and possibly modify those objects. Accordingly, the present system further includes a speech recognition engine 456. The speech recognition engine 456 may operate according to any of various known technologies.

In one example embodiment, the head mounted display device 32 and processing unit 36 work together to create the scene map or model of the environment that the user is in and tracks various moving or stationary objects in that environment. In addition, the processing unit 36 tracks the FOV of the head mounted display device 32 worn by the user 18 by tracking the position and orientation of the head mounted display device 32. Sensor information, for example from the forward-facing cameras 112 and IMU 132, obtained by head mounted display device 32 is transmitted to processing unit 36. The processing unit 36 processes the data and updates the scene model. The processing unit 36 further provides instructions to head mounted display device 32 on where, when and how to insert any holographic, three-dimensional objects. Each of the above-described operations will now be described in greater detail with reference to the flowchart of FIG. 7.

FIG. 7 is a high level flowchart of the operation and interactivity of the processing unit 36 and head mounted display device 32 during a discrete time period such as the time it takes to generate, render and display a single frame of image data to each user. In embodiments, data may be refreshed at a rate of 60 Hz to 90 Hz, though it may be refreshed more often or less often in further embodiments.

In general, the system may generate a scene map having x, y, z coordinates of the environment and objects in the environment such as holographic objects and real world objects. For a given frame of image data, a user's view may include one or more real and/or virtual objects. The system for presenting a virtual environment to one or more users may be configured in step 600. Step 600 may for example involve retrieving from memory the stored, last-known positions and appearances of holographic objects. The last known positions and appearances may be the positions and appearances when the user last viewed the holographic objects. The memory from which this data is retrieved may be the memory 330 of the processing unit 36, the memory 244 of the head mounted display device 32, or the memory of a remote computer, including for example one or more servers of a service provider supporting the present technology. Positions of holographic and real objects in the scene may be defined in an arbitrary 3-D coordinate system. Alternatively, the positions of holographic and real objects in the scene may be defined by GPS coordinates.

In embodiments, holographic plants created by a user may remain stored and displayed to the user when the user later returns to the location where the holographic plants were created. Holographic plants created by a user may be visible only to that user. In further embodiments, created holographic plants may be visible to other users having permission from the creating user, or the holographic plants may be visible to all users.

As explained below, the appearance of holographic objects retrieved from memory may be modified, for example to show how much they have grown since last viewed. The amount by which holographic objects may be modified may be based at least in part on environmental sensor data received from the environmental sensors 138. However, the appearance of holographic objects may also or alternatively be based on historical environmental data stored on a remote computer. This historical environmental data may for example include weather conditions, air quality and the amount of rain that has fallen at the location of the holographic objects since the user last viewed the holographic objects. This historical environmental data may be obtained in the configuration step 600.

In step 604, the processing unit 36 gathers data from the scene. This may be image data sensed by the head mounted display device 32, and in particular, by the forward-facing cameras 112, the eye tracking assemblies 134 and the IMU 132. A scene map may be developed in step 610 identifying the geometry of the scene as well as the geometry and positions of objects within the scene. In embodiments, the scene map generated in a given frame may include the x, y and z positions of a user's hand(s), other real world objects and holographic objects in the scene. Methods for gathering depth and position data relative to the head mounted display device 32 have been explained above.

The processing unit 36 may next translate the image data points captured by the sensors into an orthogonal 3-D scene map. This orthogonal 3-D scene map may be a point cloud map of all image data captured by the head mounted display device cameras in an orthogonal x, y, z Cartesian coordinate system. Methods using matrix transformation equations for translating camera view to an orthogonal 3-D world view are known. See, for example, David H. Eberly, “3d Game Engine Design: A Practical Approach To Real-Time Computer Graphics,” Morgan Kaufman Publishers (2000).

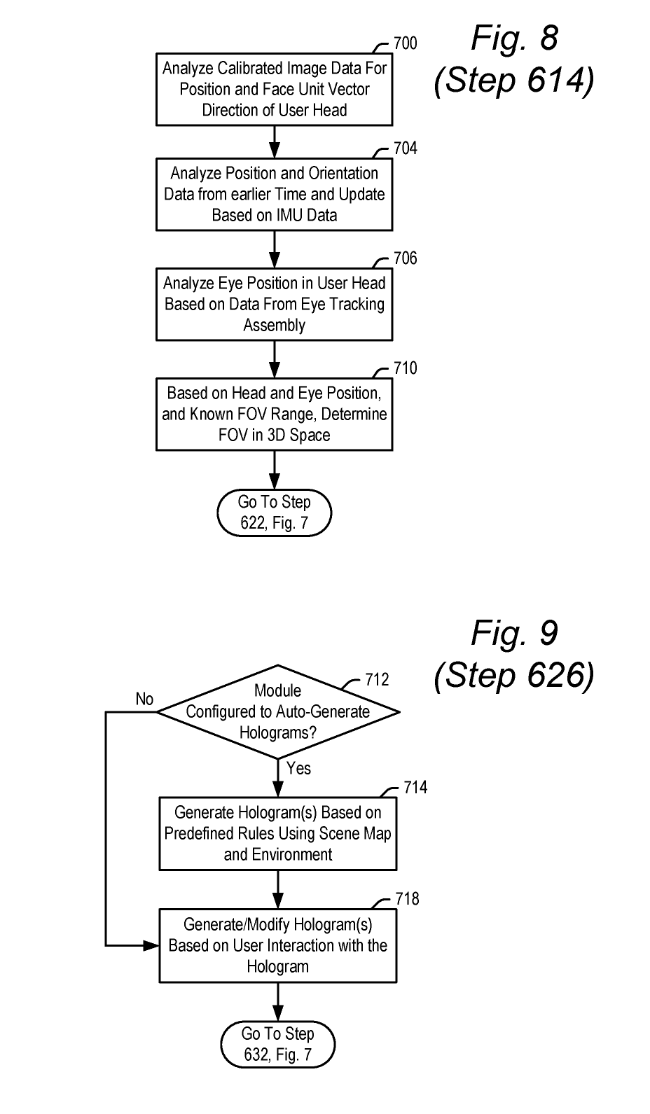

In step 612, the system may detect and track a user's skeleton and/or hands as described above, and update the scene map based on the positions of moving body parts and other moving objects. In step 614, the processing unit 36 determines the x, y and z position, the orientation and the FOV of the head mounted display device 32 within the scene. Further details of step 614 are now described with respect to the flowchart of FIG. 8.

In step 700, the image data for the scene is analyzed by the processing unit 36 to determine both the user head position and a face unit vector looking straight out from a user's face. The head position may be identified from feedback from the head mounted display device 32, and from this, the face unit vector may be constructed. The face unit vector may be used to define the user's head orientation and, in examples, may be considered the center of the FOV for the user. The face unit vector may also or alternatively be identified from the camera image data returned from the forward-facing cameras 112 on head mounted display device 32. In particular, based on what the cameras 112 on head mounted display device 32 see, the processing unit 36 is able to determine the face unit vector representing a user's head orientation.

In step 704, the position and orientation of a user's head may also or alternatively be determined from analysis of the position and orientation of the user's head from an earlier time (either earlier in the frame or from a prior frame), and then using the inertial information from the IMU 132 to update the position and orientation of a user's head. Information from the IMU 132 may provide accurate kinematic data for a user's head, but the IMU typically does not provide absolute position information regarding a user's head. This absolute position information, also referred to as “ground truth,” may be provided from the image data obtained from the cameras on the head mounted display device 32.

In embodiments, the position and orientation of a user's head may be determined by steps 700 and 704 acting in tandem. In further embodiments, one or the other of steps 700 and 704 may be used to determine head position and orientation of a user's head.

It may happen that a user is not looking straight ahead. Therefore, in addition to identifying user head position and orientation, the processing unit may further consider the position of the user's eyes in his head. This information may be provided by the eye tracking assembly 134 described above. The eye tracking assembly is able to identify a position of the user's eyes, which can be represented as an eye unit vector showing the left, right, up and/or down deviation from a position where the user's eyes are centered and looking straight ahead (i.e., the face unit vector). A face unit vector may be adjusted to the eye unit vector to define where the user is looking.

In step 710, the FOV of the user may next be determined. The range of view of a user of a head mounted display device 32 may be predefined based on the up, down, left and right peripheral vision of a hypothetical user. In order to ensure that the FOV calculated for a given user includes objects that a particular user may be able to see at the extents of the FOV, this hypothetical user may be taken as one having a maximum possible peripheral vision. Some predetermined extra FOV may be added to this to ensure that enough data is captured for a given user in embodiments.

The FOV for the user at a given instant may then be calculated by taking the range of view and centering it around the face unit vector, adjusted by any deviation of the eye unit vector. In addition to defining what a user is looking at in a given instant, this determination of a user's FOV is also useful for determining what may not be visible to the user. Limiting processing of virtual objects to those areas that are within a particular user's FOV may improve processing speed and reduces latency.

Referring again to FIG. 7, in step 622 the processing unit 36 may next check whether a new holographic plant (or other holographic object) is being generated automatically or by a user, or whether an existing holographic plant or other object is being modified by a user. If so, the position and/or appearance of the holographic plant or object is generated or modified in step 626. Further details of step 626 will now be explained with reference to the flowchart of FIG. 9.

Generation and/or modification of holographic plants and other objects is performed by the plant generation and growth module 448 executing for example on the processing unit 36. The plant generation and growth module 448 may be configured to automatically generate holographic plants or other virtual objects. This check is performed in step 712. If so, the module 448 may generate holographic plants or other virtual objects in step 714. In particular, the plant generation and growth module 448 may have data describing a number of predefined plants stored in memory, including parameters for each stored plant. These parameters may include for example size range (e.g., seedling to fully matured), developmental stages and appearances as the plant grows, rate of growth and environmental conditions under which the plant thrives and/or does poorly. These parameters may further include care and supplements which aid growth. For example, parameters associated with fruits, flowers and other plants may include an amount of water required for optimal growth, and/or an amount or type of soil, fertilizer or pesticides required for optimal growth. The parameters may include additional features regarding specific plants in further embodiments.

The plant generation and growth module 448 may further have predefined rules dictating when and how to auto-generate holographic plants and/or other objects such as holographic wildlife. These predefined rules may be based on environmental conditions at a particular location. For example, the module 448 may first check whether a particular area within the FOV of the user is partially or entirely empty and has room for holographic plants to be generated and grow. Next, the module 448 may check the environmental sensor data generated by the one or more environmental sensors 138, and/or the historical environmental data for that location downloaded from a remote computer in step 600. The module 448 may next run through its predefined rules to see what plants may typically exist in the real-world given the available space and environmental conditions at the location.

Based on the above determinations, the module 448 may then auto-generate one or more holographic plants that were determined to be appropriate for that location at selected positions within the location. In embodiments, the auto-generated holographic plants may be generated and displayed as seedlings (e.g., up to about 1 inch) or saplings (e.g., between 1 and 6 inches). Thereafter, a user may watch the holographic plants virtually grow and thrive as explained below. However, the auto-generated holographic plants may be generated and initially displayed in later stages of development, including fully matured, in further embodiments.

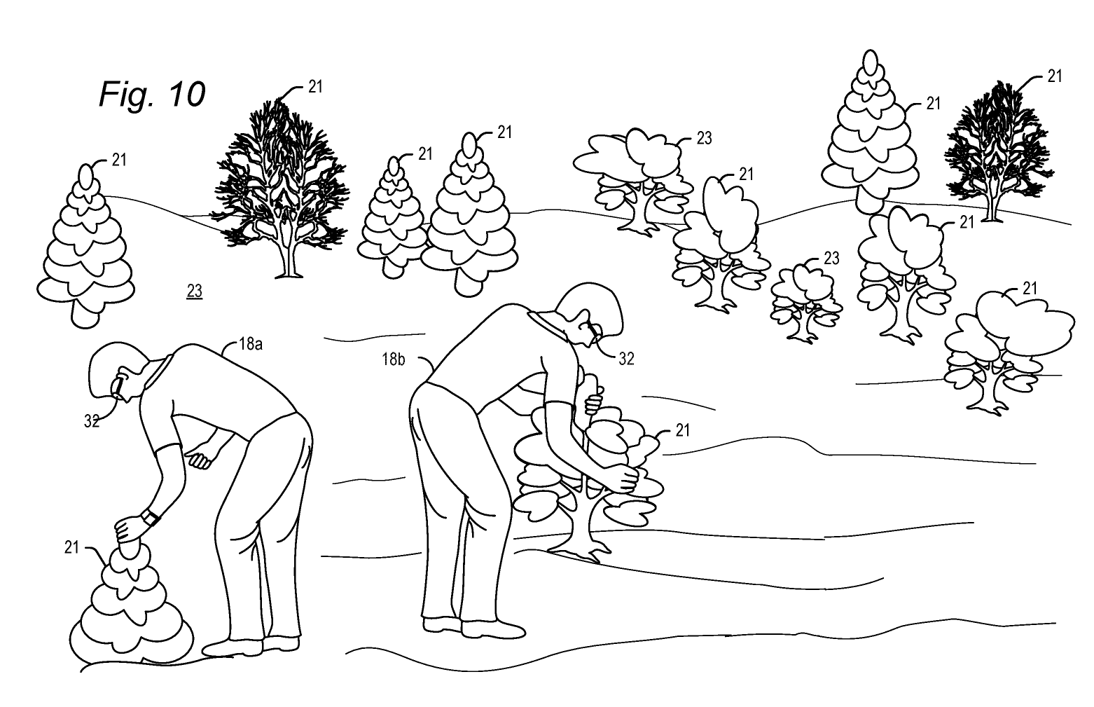

In step 712, the plant generation and growth module 448 may alternatively be configured to generate or modify holographic plants based on input from the user. If so, holographic plants may be generated and/or modified in step 718 based on user interaction with the holographic plants. For example, FIG. 10 is an illustration of a pair of users 18a and 18b generating and/or modifying holographic plants 21 at a real world location 23. As one of a wide variety of examples, user interaction may include a user 18 performing a predefined gesture or verbal command. The predefined gesture or verbal command may for example cause the processing unit 36 to display a visual menu to the user via the head mounted display 32 with a list of predefined and available plants to create. The menu may also possibly recommend which predefined plants tend to thrive in the environmental conditions at the location of the user. The user may thereafter indicate a position (for example by pointing, eye gaze or contacting the position) where a selected predefined plant is to be planted. The selected holographic plant may then be generated and displayed at that position.

A user may thereafter modify a newly created or already existing holographic plant by further gestures and/or interactions with the holographic plant. For example, FIG. 10 shows a user 18a “pulling” on a holographic plant 21 to thereby increase its height (diameter may stay constant) and/or scale its size (both height and diameter increase proportionately to each other). The user may “pull” on the holographic plant 21 by positioning his or her hand at a location in three-dimensional space occupied by a top (or other) portion of the holographic plant 21. The mobile computing device 30 may interpret this action as a predefined gesture to change the size of the holographic plant 21, by either moving his/her hand upward (“pulling” on the holographic plant) or moving his/her hand downward (“pushing” on the holographic plant). FIG. 10 further shows a user 18b “pulling” or “pushing” on individual sections of the holographic plant to increase or decrease the size of the individual section of the holographic plant.

In embodiments, increasing the size of a holographic plant may not only change its size, but may also alter the appearance of the holographic plant to show further stages in the maturity of the plant. For example, where a plant develops petals and pistils during later stages of maturations, these may be displayed where a user increases the size of a holographic plant. A user may perform a wide variety of other predefined gestures, for example to move a holographic plant or remove a holographic plant.

It is a feature of the plant generation and growth module 448 to change the appearance of a holographic plant to more advanced developmental stages over time where the holographic plant is generated at a location, taking into account environmental conditions that are favorable to the growth of that type of plant. Thus, where a holographic plant is created in an area with environmental conditions that are favorable to that type of plant, the holographic plant may grow over time and/or have a healthier, more robust appearance. Additionally, certain plants go through distinct developmental stages, such as flowers appearing on flowering plants, or vegetables appearing on planted crops. The holographic plants may be shown to advance through these distinct developmental stages where the environmental conditions are favorable to that type of plant. Conversely, in embodiments, where a plant is created in an area that has environmental conditions that are unfavorable to that type of plant, the plant may regress, for example being displayed as withering over time. User care may also be a factor determining whether an appearance of a plant changes to a more developmental stage or withers over time.

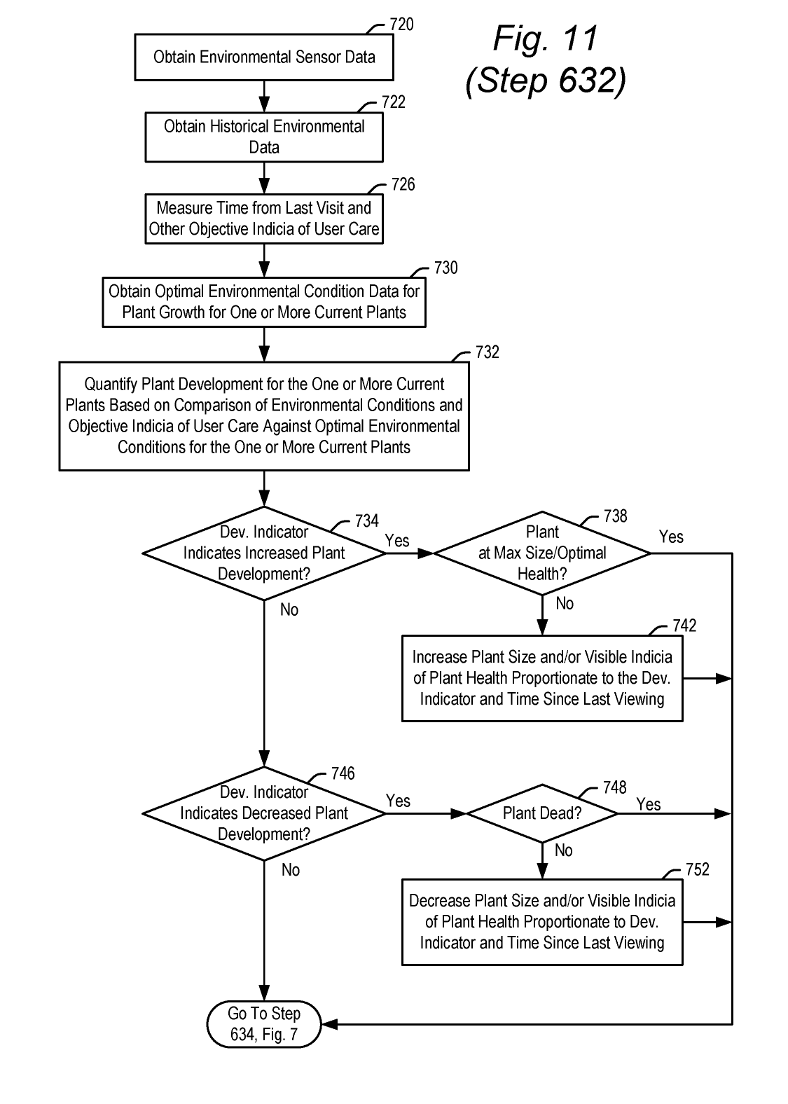

Referring again to FIG. 7, after steps 622 and/or 626, the plant generation and growth module 448 may perform a step 632 of modifying one or more holographic plants to indicate development of the holographic plants, based on factors including environmental conditions and/or user care for the holographic plants. Further details of step 632 will now be explained with reference to the flowchart of FIG. 11.

In step 720, the processing unit 36 obtains the environmental sensor data from the one or more environmental sensors 138. As indicated above, the one or more sensors 138 may measure data indicative of a variety of environmental conditions, including for example temperature, humidity, atmospheric pressure, amount of rainfall over time, air-quality, etc.

As explained below, the plant generation and growth module 448 may use the sensed environmental conditions, and the length of time since the last visit to the location of the holographic plant(s), to determine a degree of change in appearance of the holographic plant(s) relative to the previous visit. However, the data presented by the environmental sensors 138 provides a snapshot of the environmental conditions at the time a user is present at a location of the holographic plants (e.g., field 23b of FIG. 1). While the snapshot of the environmental conditions may be a good indication of the environmental conditions in the past, it is also possible that one or more of the environmental conditions in the snapshot is anomalous.

Therefore, instead of or in addition to using the sensed environmental condition data, the plant generation and growth module 448 may obtain historical environmental condition data for the location of the holographic plants in step 722. This data may include information such as temperature, humidity, atmospheric pressure, amount of rainfall, air-quality, etc. over a recent period of time, and may be downloaded from one or more remote computers, such as for example from servers of weather or meteorological websites covering the location of the holographic plants. This data may alternatively be collected on a regular schedule (i.e., daily or weekly) and stored in memory on the mobile processing device 30, or in memory of a remote computer of a service provider supporting, and accessible by, mobile processing devices 30 of multiple users.

User care may also be a factor in how or whether holographic plants thrive. In step 726, the plant generation and growth module 448 may measure various objective indicia of user care for the user's holographic plants. For example, the module 448 may measure how often a user visits his or her holographic plants. Objective indicia may further include how often a user performs predefined gestures for the virtual care of the holographic plants. For example, a gesture may be defined which creates a virtual watering can, and a further gesture may be performed to virtually water the holographic plants from the virtual watering can. The module 448 may detect how much virtual water is poured on which holographic plants, and the holographic plants may virtually grow in response.

In embodiments, objective indicia of user care may further include a type and amount of virtual supplement that a user provides to a holographic plant. For example, it may be known that use of a nutrient-rich soil, fertilizer and/or pesticide is helpful to the growth and maintenance of a particular plant. As such, a user may be provided with options to select and use one or more of a nutrient-rich virtual soil, a virtual fertilizer and/or a virtual pesticide on a holographic plant. In one example, a user may be provided with a virtual menu of these items from which a user may select the desired virtual supplements that the user wishes to apply. As explained below, a user may be shown the future effects on a holographic plant if a user chooses to provide one or more of these virtual supplements.

It is noted that some plants (e.g., certain trees) require little or no user care while other plants (e.g., certain houseplants) require more care. The amount of care needed and the amount of care provided, as measured by the objective indicia, may be taken into account when determining the development and appearance of a holographic plant as explained below.

In step 730, the plant generation and growth module 448 may obtain the optimal environmental condition data for each of a user's one or more holographic plants. As noted above, this data may be stored in memory of the mobile processing device 30 or a remote computer associated with the mobile processing device 30.

Using the data obtained in steps 720, 722, 726 and 730, the plant generation and growth module 448 may derive a quantified development indicator representing whether and to what degree a holographic plant is developing and thriving. The development indicator may take into consideration a variety of factors, including a comparison of the actual environmental conditions and user care received against the optimal environmental conditions and user care needed for optimal plant development. The development indicator may for example be a numerical value or percentage, for example varying between −100% (death of the plant) and positive 100% (maximum development of the plant).

The development indicator may also take into consideration how fragile or robust a real-world plant corresponding to the hologram is. Thus, where two holographic plants are each in less than optimal environmental conditions, the more robust plant may receive a higher development indicator.

The development indicator may be based on additional factors in further embodiments. Additionally, data from one or more of the steps 720, 722 and 726 may be omitted from the calculation of the development indicator in further embodiments. For example, the plant generation and growth module 448 may use the data from the environmental sensors 138 and omit stored historical environmental data (or vice-versa). Additionally, user care may be omitted as a factor in determining the development indicator in further embodiments. In still further embodiments, environmental data may be ignored, and the appearance of the holographic plants be based entirely on the objective indicia of user care.

In step 734, the plant generation and growth module 448 determines whether the development indicator indicates increased plant development (e.g., a greater than 0 percent development). If so, the plant generation and growth module 448 determines in step 738 whether the holographic plant has already developed to a maximum size and/or an optimal healthy-looking appearance. If so, no further changes to the appearance of the holographic plant are made at this time. On the other hand, if there is still room for the holographic plant to develop further, in step 742 the appearance of the holographic plant is changed to indicate this further development.

The change in appearance in step 742 may take into consideration a number of factors. These factors include the strength of the development indicator (a higher indicator points to a greater change in appearance). The factors may further include the length of time since the user last viewed the holographic plant(s) (a longer period of time may result in a greater change in appearance). And the factors may include the rate at which the corresponding real world plant changes (a higher rate of change may result in a greater change in appearance). These factors may be weighted according to a predefined scheme to result in an overall change factor. As noted above, the appearances of each plant may be stored in memory at a number of different developmental stages in the growth of a plant. The overall change factor may indicate how much to change the appearance of the one or more holographic plants from its current appearance retrieved from memory in step 600. The various developmental appearances may be considered as different developmental levels. Thus, the overall change factor may indicate how many levels to jump from its current appearance. It is understood that the various factors may be used in a variety of other ways to advance the developmental appearance of the one or more holographic plants.

On the other hand, if there is a large disparity between the environmental conditions/user care a holographic plant needs and the environmental conditions/user care a holographic plant is receiving, the developmental indicator may not indicate increased plant development in step 734. The plant generation and growth module 448 next checks in step 746 whether developmental indicator is negative, indicating decreased plant development (e.g., the holographic plant appears to be withering). If so, the plant generation and growth module 448 determines in step 748 whether the holographic plant has already died. If so, no further changes to the appearance of the holographic plant are made at this time. It is conceivable however, that an appearance of a holographic plant may continue to decay over time even after it has died. These various decaying appearances may be stored in memory in association with a particular type of plant.

On the other hand, if a holographic plant has not yet died and it may wither further, in step 752, the appearance of the holographic plant is changed to indicate this further withering. The change in appearance in step 752 to show further withering may take into consideration the same factors as used in step 742 to show improved development. These factors may include how negative the development indicator is, the length of time since the user last viewed the holographic plant(s), and the rate at which the corresponding real world plant withers. These factors may be weighted according to a predefined scheme to result in an overall change factor. The appearances of different withering states of each plant may be stored in memory. The overall change factor may indicate how many levels of withering appearances to jump from its current appearance.

As explained below, one feature of the present technology is to get people excited about planting trees and other plants. As showing holographic plants withering and dying may have the opposite effect, steps 746-752 of showing a plant withering or dying may be omitted in embodiments of the present technology.

If the developmental indicator is neither positive in step 734, nor negative in step 746, for a given holographic plant, the flow may return to step 634 in FIG. 7 with the appearance of that plant remaining unchanged.

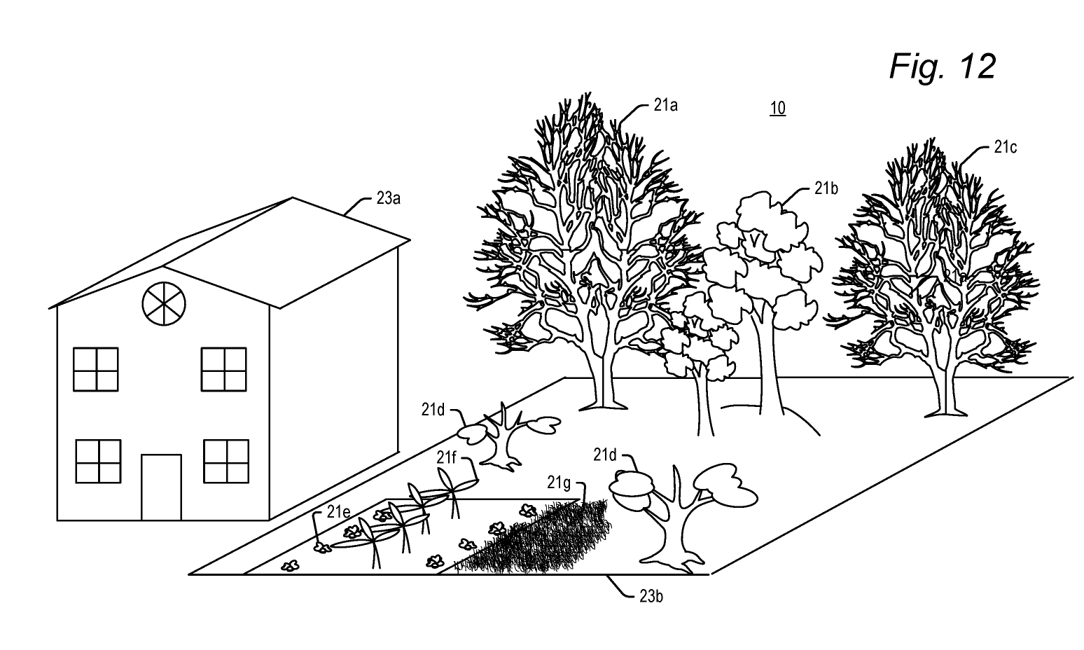

FIG. 12 shows the same augmented reality scene as in FIG. 1 (viewed through the head mounted display device 32) at some later period of time. In this example, the shrubs 21h appearing at the earlier time have been removed from the view shown at the later time of FIG. 12. The shrubs 21h may for example have been removed by user gestures described with respect to the steps of FIG. 9 described above. Trees 21b and 21c, and crops 21f have thrived, increasing in size and becoming more developed. On the other hand, trees 21d and crops 21e have withered in appearance. The appearance of tree 21a and grass 21g remains unchanged. These changes may have occurred by running through the steps of FIG. 11 described above for each of the holographic plants 21 in the scene.

As evidenced by FIG. 12, some plants may thrive while others wither even though all are subject to the same environmental conditions. This may be due to the fact that some plants received better user care, and/or that some plants respond better to the environmental conditions at field 23b than others. In embodiments, the rate at which a holographic plant develops or withers under a set of environmental conditions may be the same time period over which a real plant corresponding to the holographic plant would develop or wither in the same set of environmental conditions. In alternative embodiments, the holographic plant may develop or wither at an accelerated rate as compared to the real plant corresponding to the holographic plant. For example, in embodiments, a holographic plant may visibly grow immediately upon receiving user care such as virtual water from a virtual watering can as described above.

In further embodiments, in addition to displaying a holographic plant, supplemental information for the holographic plant may be displayed to a user in addition to merely its appearance. For example, the system can display text or some other visual indicator relating to the plant's current health. The supplemental information may include a prediction as to the health of a plant at some time in the future, given current environmental conditions and user care provided. The system can further display what virtual care a user can provide for optimal health of a given holographic plant 21. This supplemental information may automatically be displayed appurtenant a holographic plant, or may appear when a user performs a physical or verbal gesture to display this supplemental information. The type and detail of supplemental information to be displayed for a holographic plant may also be selected from a holographic menu, which gets displayed upon a user performing a predefined physical or verbal gesture.

Information about the future health of one or more holographic plants may be provided to the user in other ways in further embodiments. In one such embodiment, a user may perform a physical or verbal gesture which prompts the system to display one or more holographic plants at some time in the future, with the one or more holographic plants changed from their current state based on the predicted future health of the one or more plants. The amount of time into the future may be selected by the user or set by default in the plant generation and growth module 448.

In addition to showing a future health of one or more holographic plants given current environment and virtual care, a user may also be provided with an option to test the effects of different virtual care and be shown the future results. For example, a user may be given an option to see what would happen in the future if the user watered the holographic plant more or less than a current routine. Or a user may be given the option to see what would happen in the future if the user applied different types of fertilizers or pesticides. These options may be provided to the user in a virtual menu displayed to the user. The user may select a particular objective indicia of care (such as water or virtual supplement), and then the mobile processing device 30 may display a predicted condition of the holographic plant at some time in the future, having received that objective indicia of care. In this way, the user can see the future effects of different amounts of watering, and different supplements, and be shown what is likely to be the most effective care routine for a holographic plant 21.

It is understood that the steps of FIG. 11 show one of many possible schemes for determining a change in appearance in the one or more holographic plants. Using one or more of the above-described factors relating to what a holographic plant needs versus what it is being provided, a variety of different schemes may be used to determine a change in appearance in a holographic plant, either positively or negatively.

As noted, it is a feature of the present technology to show changes in the health and appearance of holographic plants to a user over time (either in real time or in some accelerated timeframe). However, in further embodiments, a user may additionally or alternatively be sent notifications and updates of changes to holographic plants. These notifications may be sent to a user's computing device or smart phone, for example as an email or text. These notifications may also be stored in a user account kept by a service provider. In addition to changes, notifications and alerts may be sent to a user or user account reminding the user that it is time to take some action with regard to the care of one or more of the holographic plants they have created (or are otherwise caring for). While there are advantages to a user visiting the virtual plants under his or her care, it is conceivable that a user provide virtual care remotely. For example, upon receiving a text reminder that it is time to water a holographic plant, the user may respond with a holographic text to virtually water the holographic plant, even where the user is remote from the holographic plant.

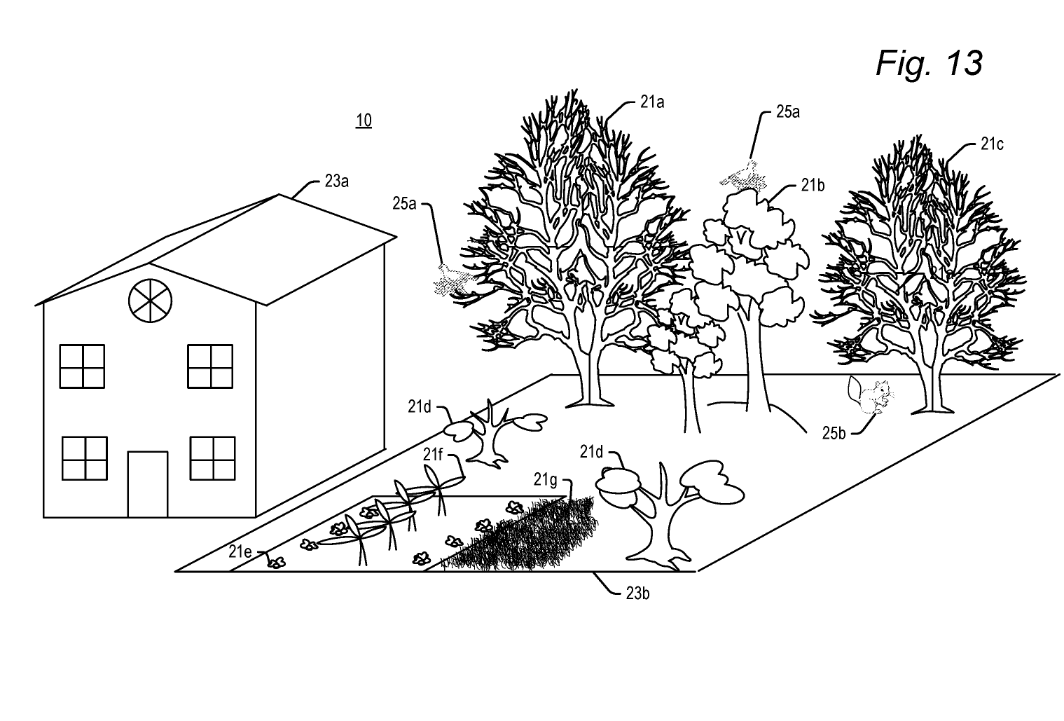

In the real world, as plants including for example trees develop, wildlife may choose to make their homes there. This feature may also be incorporated into the augmented reality environment of the present technology. For example, as shown in FIG. 13, as trees 21a, 21b and 21c develop, they may “attract” wildlife 25. That is, the plant generation and growth module 448 may store predefined rules which indicate to add certain types of holographic wildlife to certain types of holographic plants when the holographic plants reach a threshold developmental stage.

In the example of FIG. 13, holographic birds 25a are shown nesting in trees 21a and 21b, and a holographic squirrel 25b is shown on the ground of field 23b in the proximity of tree 21c. It is understood that a wide variety of other or additional holographic wildlife may be added to the augmented reality scene, including other types of animals, birds and/or insects. The type of holographic wildlife which may be added to holographic plants may mirror which types of real world wildlife live in or around which types of real world plants.

In addition to holographic plants giving rise to wildlife, wildlife may foster or otherwise affect holographic plants. For example, insects, birds and other wildlife may cause pollination and lead to additional holographic plants being generated and displayed. In a further example, some holographic birds or insects may eat or otherwise damage holographic plants (in the absence of a virtual pesticide). The effects of holographic plants and wildlife, and the responsive effects of wildlife on plants, may be programmed as part of the plant generation and growth module 448 and displayed to a user.

Once holographic wildlife is added to the augmented reality scene, the holographic wildlife may be dynamic, meaning that the wildlife may move in and/or around a holographic plant with which it is associated. The movement of the wildlife holograms may be defined according to a wide variety of schemes stored in the plant generation and growth module 448.

In embodiments, the holographic plants may also be dynamic, for example swaying with a wind, to provide a more realistic user experience. In such embodiments, the head mounted display device 32 may further include a sensor for measuring a direction and magnitude of wind. Thus, the holographic plants may appear to sway in the direction of the wind, and the amount they sway may be proportional to the amount of wind present and sensed. It is possible that some or all of the holographic plants be made static in further embodiments, so that they do not move regardless of wind.

As noted above, the generation and growth of holographic plants may affect the environment by attracting virtual wildlife. However, the holographic plants may have other effects on the environment. For example, real trees draw water up from the ground which evaporates from the leaves in a process called transpiration. Transpiration can reduce temperatures and increase rainfall in a given area. Trees and other plants also improve air quality, and increase shade which may further reduce temperatures. These effects of holographic plants on air quality and weather conditions may also be programmed into the plant generation and growth module 488, which may in turn use these changed environmental conditions in controlling holographic plant growth.

Referring again to FIG. 7, in step 634, the processing unit 36 may cull the rendering operations so that just those virtual objects which could possibly appear within the final FOV of the head mounted display device 32 are rendered. The positions of other virtual objects may still be tracked, but they are not rendered. It is also conceivable that, in further embodiments, step 634 may be skipped altogether and the entire image is rendered.

The processing unit 36 may next perform a rendering setup step 638 where setup rendering operations are performed using the scene map and FOV received in steps 610 and 614. Once holographic object data is received (holographic plants and, possibly holographic wildlife), the processing unit may perform rendering setup operations in step 638 for the holographic objects which are to be rendered in the FOV. The setup rendering operations in step 638 may include common rendering tasks associated with the holographic object(s) to be displayed in the final FOV. These rendering tasks may include for example, shadow map generation, lighting, and animation. In embodiments, the rendering setup step 638 may further include a compilation of likely draw information such as vertex buffers, textures and states for virtual objects to be displayed in the predicted final FOV.

Using the information regarding the locations of objects in the 3-D scene map, the processing unit 36 may next determine occlusions and shading in the user's FOV in step 644. In particular, the scene map has x, y and z positions of objects in the scene, including any moving and non-moving holographic or real objects. Knowing the location of a user and their line of sight to objects in the FOV, the processing unit 36 may then determine whether a holographic object partially or fully occludes the user's view of a real world object. Additionally, the processing unit 36 may determine whether a real world object partially or fully occludes the user's view of a holographic object.

In step 646, the GPU 322 of processing unit 36 may next render an image to be displayed to the user. Portions of the rendering operations may have already been performed in the rendering setup step 638 and periodically updated. Any occluded holographic objects may not be rendered, or they may be rendered. Where rendered, occluded objects will be omitted from display by the opacity filter 114 as explained above.

In step 650, the processing unit 36 checks whether it is time to send a rendered image to the head mounted display device 32, or whether there is still time for further refinement of the image using more recent position feedback data from the head mounted display device 32. In a system using a 60 Hertz frame refresh rate, a single frame is about 16 ms.

If it is time to display an updated image, the images for the one or more holographic objects are sent to microdisplay 120 to be displayed at the appropriate pixels, accounting for perspective and occlusions. At this time, the control data for the opacity filter is also transmitted from processing unit 36 to head mounted display device 32 to control opacity filter 114. The head mounted display would then display the image to the user in step 658.

On the other hand, where it is not yet time to send a frame of image data to be displayed in step 650, the processing unit may loop back for more recent sensor data to refine the predictions of the final FOV and the final positions of objects in the FOV. In particular, if there is still time in step 650, the processing unit 36 may return to step 604 to get more recent position sensor data from the head mounted display device 32.

The processing steps 600 through 658 are described above by way of example only. It is understood that one or more of these steps may be omitted in further embodiments, the steps may be performed in differing order, or additional steps may be added.

The present technology as described above provides several advantages. In addition to being aesthetically pleasing, studies have shown that experiencing plants and wildlife reduces stress and has a positive effect on mental health. Users may experience these benefits from the holographic plants of the present technology. Moreover, the beauty and mental health benefits may inspire users to plant trees, gardens and other plants. Once a user sees how beautiful an empty field or area could be with the addition of plants, the user may want to plant there in real life.

Additionally, the present technology educates users in the planting and growing of trees and other foliage. The present technology provides information and recommendations as to what plants will do well in a given area, and how best to care for the plants once created. Armed with this knowledge, users may be further inspired to create plants in the real world. Moreover, users gain a sense of reward and accomplishment as they watch the holographic plants they created grow with the care that they provide. This sense of reward and accomplishment may again inspire users to recreate their holographic experience in the real world.

Showing plants withering may be contrary to the above-stated advantages of fostering interest in planting. As such, as noted above, in further embodiments of the present technology, showing a withering appearance of a plant (steps 746, 748 and 752 of FIG. 11) may be omitted so that plants are shown as either developing or remaining unchanged.

In embodiments which do include withering the appearance of plants, such embodiments may further include an appearance of a negative impact to a plant due to a catastrophic environmental event. For example, if a real-world tornado, fire or hurricane passes through a location including holographic plants, those plants may be shown as withered, decimated or destroyed after the catastrophic event. This feature may be omitted in further embodiments.

While fostering interest in planting trees and other plants is a feature of the present technology, the present technology has additional advantages. For example, the present technology may advantageously be used for planning purposes where a user wishes to see how a landscape will look with certain plants, and easily swap out and try different plants. The user can also see how the plants will grow over time, and what it may take to sustain and develop the plants over time. The present technology may further be used as a group exercise. For example, FIG. 10 shows two users building a holographic forest or garden together. There may be more than two users in further embodiments. Each user can see holographic plants created by others, from their own perspective.

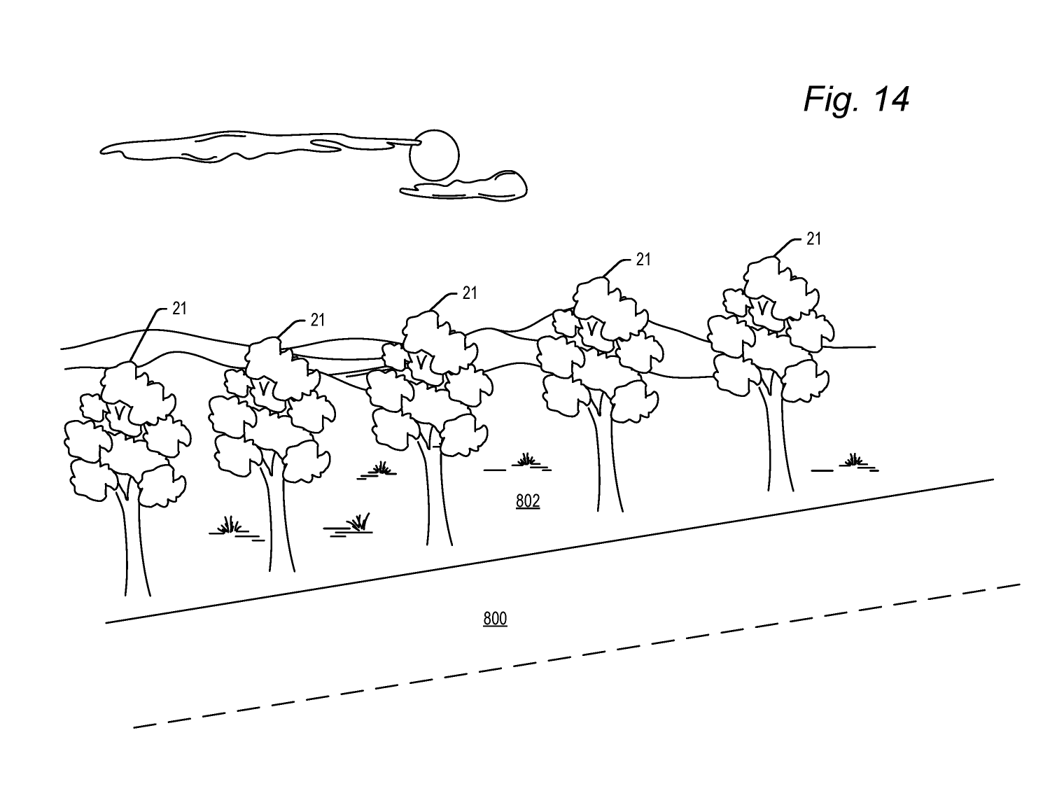

FIG. 14 illustrates a further feature of the present technology. As a user is traveling in a vehicle down a roadway 800, for example in a car or a bus, the user may look out of his or her head mounted display device 32 onto the road side landscape 802 and see holographic trees and/or other holographic plants 21. As an alternative, the vehicle may be a train, and the user may look out of his or her head mounted display device 32 onto a landscape passed by the train and see holographic trees and/or other holographic plants 21.

The holographic plants 21 in this embodiment may be created in real time as the user passes by, for example in accordance with predefined rules indicating the types of plants which may be appropriate to the landscape 802 as sensed by the head mounted display device 32. The landscape 802 may be shown with any of a wide variety of holographic plants 21 in further embodiments. Once a user sees how beautiful a road side could be with the addition of plants, this feature of the present technology again advantageously fosters an interest in users to create real life plants.

Embodiments described above have added holographic plants to a real world environment, such as the field 23b of FIGS. 1 and 12. However, in further embodiments, holographic plants may be generated and modified as described above in a completely virtual environment. In such an embodiment, the area where the holographic plants are created may itself be a displayed hologram.

In summary, an example of the present technology relates to a system for presenting an augmented reality environment, the system comprising: a display for displaying holographic objects to a user superimposed on a real world area; one or more sensors for sensing environmental conditions in the real world area; and a processor for generating the holographic objects in the form of one or more holographic plants, the processor changing one or more appearances of the one or more holographic plants over time at least in part in response to one of feedback from the one or more sensors of the environmental conditions, and historical data relating to environmental conditions at the real world area.

Another example of the present technology relates to a system for presenting an augmented reality environment, the system comprising a display for displaying holographic objects to a user superimposed on a real world area; and a processor for generating the holographic objects in the form of one or more holographic plants, the processor changing one or more appearances of the one or more holographic plants over time at least in part in response to one of environmental conditions at the real world area and objective indicia of user care for the one or more holographic plants.

In a further example, the present technology relates to a system for presenting an augmented reality environment, the system comprising: a display for displaying holographic objects to a user superimposed on a real world area; and a processor for generating the holographic objects in the form of a holographic plant, the holographic plant selected based on the real world area being favorable to the type of plant corresponding to the holographic plant.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. It is intended that the scope of the invention be defined by the claims appended hereto.

We claim:

1. A system for presenting an augmented reality environment, the system comprising:
a display for displaying holographic objects to a user superimposed on a real world area;
one or more sensors for sensing environmental conditions in the real world area; and
a processor for generating the holographic objects in the form of one or more holographic plants, the processor changing one or more appearances of the one or more holographic plants over time at least in part in response to at least one of feedback from the one or more sensors of the environmental conditions, and historical data relating to environmental conditions at the real world area.

2. The system of claim 1, wherein the processor changes the appearance of a holographic plant of the one or more holographic plants over time to a more developed stage where the environmental conditions at the real world area are favorable to the type of plant corresponding to the holographic plant.

3. The system of claim 1, wherein the processor changes the appearance of a holographic plant of the one or more holographic plants over time to a more withered appearance where the environmental conditions at the real world area are unfavorable to the type of plant corresponding to the holographic plant.

4. The system of claim 1, wherein the processor changes the appearance of a holographic plant of the one or more holographic plants to a more developed stage where the system detects objective indicia of user care.

5. The system of claim 4, wherein the objective indicia of user care comprise one or more predefined gestures.

6. The system of claim 5, wherein the one or more predefined gestures include a predefined gesture for watering the plant.

7. The system of claim 1, wherein the processor further changes the appearance of a holographic plant of the one or more holographic plants in response to interaction with the holographic plant by a user.

8. The system of claim 7, wherein the interaction comprises a user performing a gesture to change a size of the holographic plant.

9. The system of claim 1, the one or more holographic plants comprising one or more of holographic trees, produce, grass, shrubs, flowers, herbs, ferns and mosses.

10. A system for presenting an augmented reality environment, the system comprising:
a display for displaying holographic objects to a user superimposed on a real world area; and
a processor for generating the holographic objects in the form of one or more holographic plants, the processor changing one or more appearances of the one or more holographic plants over time at least in part in response to at least one of environmental conditions at the real world area and objective indicia of user care for the one or more holographic plants.

11. The system of claim 10, wherein the processor automatically generates the one or more holographic plants.

12. The system of claim 11, wherein the processor automatically generates the one or more holographic plants based on which plants would favorably develop in environmental conditions at the real world area.

13. The system of claim 10, wherein the processor generates the one or more holographic plants based on selection of the one or more plants by a user.

14. The system of claim 10, wherein the processor changes the appearance of a holographic plant of the one or more holographic plants over time to a more developed stage where the environmental conditions at the real world area are favorable to the type of plant corresponding to the holographic plant.

15. The system of claim 14, wherein the processor generates a holographic object in the form of holographic wildlife in or around the holographic plant where the appearance of the holographic plant has changed over time to a threshold developmental stage.

16. The system of claim 10, wherein the processor changes the appearance of a holographic plant of the one or more holographic plants over time to a more withered appearance where the environmental conditions at the real world area are unfavorable to the type of plant corresponding to the holographic plant.

17. A system for presenting an augmented reality environment, the system comprising:
a display for displaying holographic objects to a user superimposed on a real world area; and
a processor for generating the holographic objects in the form of a holographic plant, the holographic plant selected based on the real world area being favorable to the type of plant corresponding to the holographic plant.

18. The method of claim 17, wherein the real world area is a landscape passed by while a user is riding in a vehicle.

19. The method of claim 17, wherein the real world area is one of a field or indoors area.

20. The method of claim 19, the processor further changing an appearance of the holographic plant over time at least in part in response to one of the favorable environmental conditions at the real world area and an objective indicia of user care for the holographic plant.
